(19) United States
(12) Patent Application Publication
(10) Pub. No.: US 2008/0105312 A1
(43) Pub. Date: May 8, 2008

(54) Decorative faucet

(75) Inventor: Chun-Hui Lin, Taipei (TW)

Correspondence Address: TROXELL LAW OFFICE PLLC;SUITE 1404, 5205 LEESBURG PIKE, FALLS CHURCH, VA, 22041, US

(73) Assignee: Hocheng Corporation, Taipei (TW)

(21) Appl. No.: 11/647,223

(22) Filed: Dec. 29, 2006

(30) Foreign Application Priority Data
Nov. 2, 2006 (TW) 095219364

(51) Int. Cl. F16K 21/00

(52) U.S. Cl. 137/801

(57) ABSTRACT

Components of a faucet are assembled together in a container as a whole. Thus, the faucet is easily installed. Besides, a surface of the container is decorative which adds beauty to a wall where the faucet is installed.

### FIELD OF THE INVENTION

The present invention relates to a faucet; more particularly, relates to modulating the faucet for beauty and easy installation.

### DESCRIPTION OF THE RELATED ARTS

A general spigot is made of metal with an ‘L’ shape and has a water inlet and a water outlet at two ends separately. The water inlet has an outer screw; a valve is located between the water inlet and the water outlet and, the valve is connected with a turning member. Thus, the water supplying tube (a cool or hot water tube) is connected by using the outer screw. And a user opens or closes the spigot with the valve by turning the turning member so that water flows from the water inlet to the water outlet through the water supplying tube for the user.

Thus, the general spigot is opened or closed by turning the turning member by the user to flow water from the water inlet to the water outlet; and, each of the cool water hose and the hot water hose has one spigot separately, where the shape of the spigot is ‘L’-like. Such an installation is not convenient and affects the beauty of the wall where the spigots are installed.

Therefore, a spigot for controlling both cool water and hot water is invented. This kind of spigot has two water inlets and one water outlet. Each of the two water inlets has an outer screw; a valve is located between the water inlets and the water outlet; and, the valve is connected with one or two turning members. Thus, cool water and/or hot water is outputted from the water outlet. But, because the spigot is located at border of a hand-washing basin or a bathtub on installing, the shape of the hand-washing basin or the bathtub is limited for a luxurious design. Moreover, when setting up the tubes, the installation may become inconvenient owing to the small room between the hand-washing basin or the bathtub and the wall surface where the spigot is installed.

Hence, the prior arts do not fulfill users' requests on actual use.

### SUMMARY OF THE INVENTION

The main purpose of the present invention is to modulate a faucet for beauty and easy installation.

To achieve the above purpose, the present invention is a decorative faucet, comprising a container having a decoration area on at least one surface; at least one spigot on the decoration area; and at least one water tap on the decoration area at a side of the spigot, where the water tap having a control valve connected to cool/hot water hoses, which are deposed at another surface of the container, and a tube, which connects to the spigot. Accordingly, a novel decorative faucet is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention;

FIG. 2 is the explosive view;

FIG. 3 is the assembly view; and

FIG. 4 is the sectional assembly view.

### DESCRIPTION OF THE PREFERRED EMBODIMENT

The following description of the preferred embodiment is provided to understand the features and the structures of the present invention.

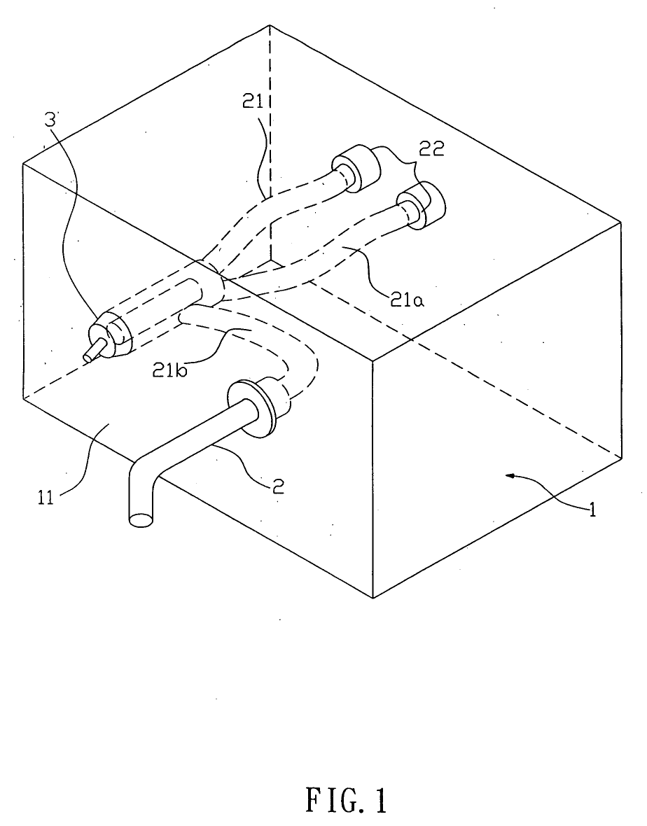

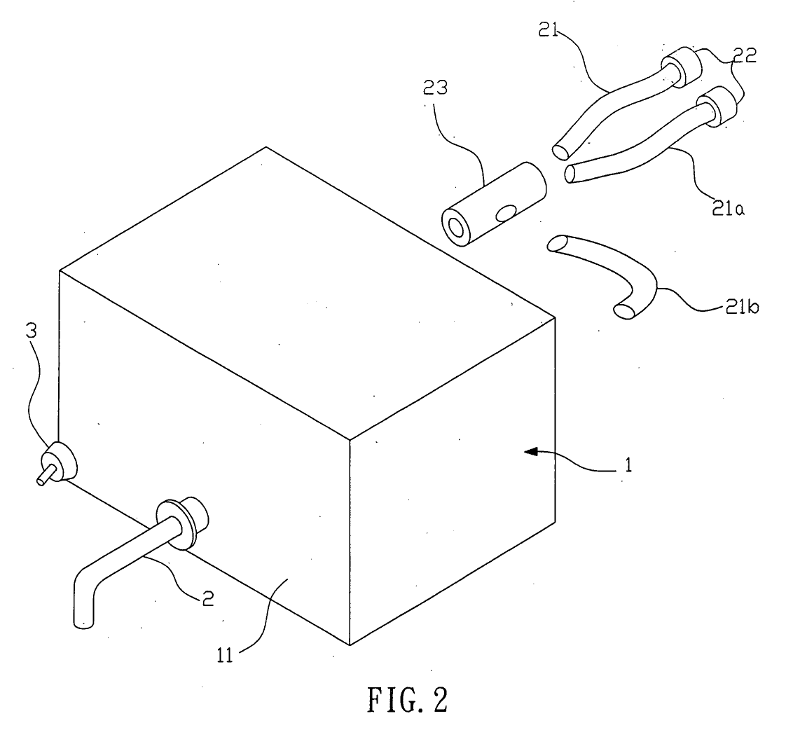

Please refer to FIG. 1 and FIG. 2, which are a perspective view and an explosive view showing a preferred embodiment according to the present invention. As shown in the figures, the present invention is a decorative faucet, comprising a container 1, at least one spigot 2 and at least one water tap 3, where the faucet is modulated for beauty and easy installation.

The container 1 has a decoration area 11, which is a mirror surface or a design surface, on at least one surface.

The spigot 2 is deposed on the decoration area 11.

The water tap 3 is deposed on the decoration area 11 at a side of the spigot 2 and has control valve 23.

The water tap 3 is operated to open and close the control valve 23. The control valve 23 is connected to cool/hot water hoses 21, 21a and a tube 21b. The cool/hot water hoses 21, 21a are deposed on another side of the container 1. The tube 21b is connected with the spigot 2. Each of the cool/hot water hoses 21, 21a has a connector 22 at an end; and the connector 22 is a sleeve having an inner screw. Thus, a novel decorative faucet is obtained.

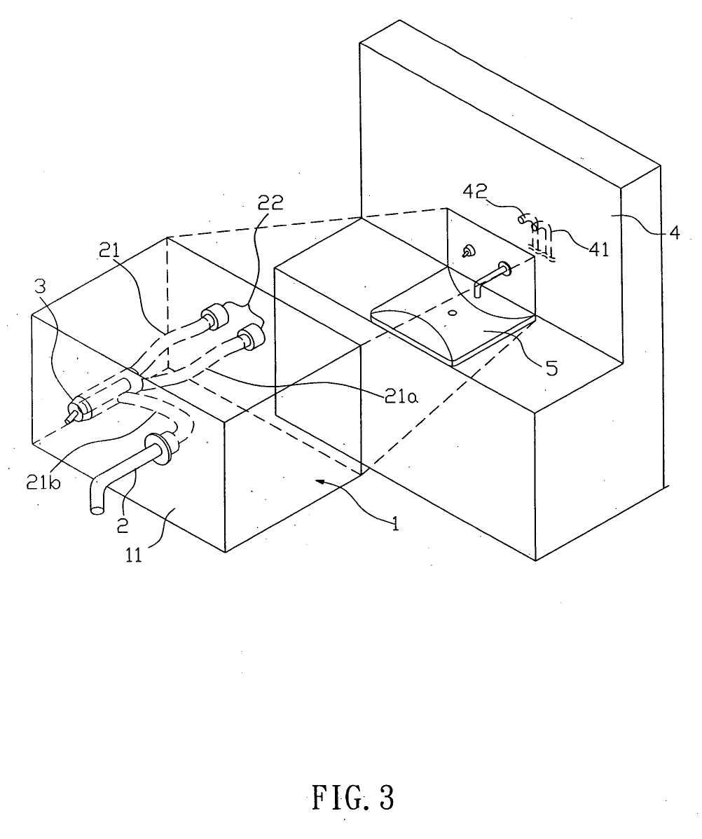

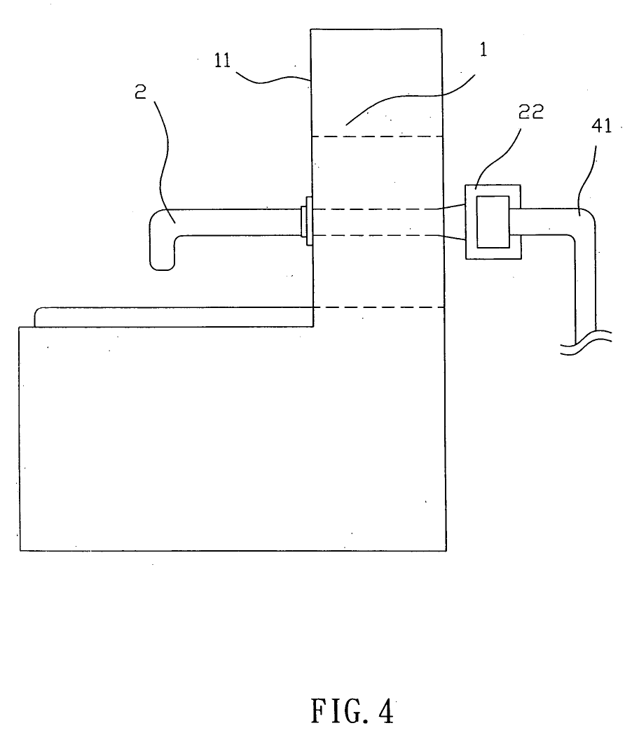

Please refer to FIG. 3 and FIG. 4, which are an assembly view and a sectional view of the assembly. As shown in the figures, when using, the present invention is used as a water supplier for a hand-washing basin 5 or a bathtub.

When assembling the present invention, cool/hot water pipes 41, 42 preserved in advance in a wall surface 4 are fixed with cool/hot water hoses 21, 21a on a surface of a container 1 through connectors 22 and then the container 1 is fixed in the wall surface 4 where a spigot is correspondingly located above the hand-washing basin. Thus, the present invention is assembled. And a user operates a water tap 2 to open or close a control valve 23 so that cool/hot water is outputted from the spigot 2 through a tube 21b from the cool/hot water hoses 21, 21a for fulfilling user's request.

Besides, a decoration area 11 of the container 1 can be a mirror surface or a design surface according to the wall surface 4 so that the wall surface becomes more beautiful with the decoration area 11 of the container 1.

To sum up, the present invention is a decorative faucet, where the faucet is modulated for beauty and easy installation.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A decorative faucet, comprising:
a container, said container having a decoration area on at least one surface of said container;
at least one spigot said spigot deposing on said decoration area of said container; and
at least one water tap, said water tap deposing on said decoration area at a side of said spigot, said water tap having a control valve, said control valve connecting to a cool water hose, a hot water hose and a tube, said cool water hose and said hot water hose deposing on an other surface of said container, said tube connecting to said spigot.

2. The faucet according to claim 1,
wherein said decoration area is a mirror surface.

3. The faucet according to claim 1,
wherein decoration area is a design surface.

4. The faucet according to claim 1,
wherein said cool water hose and said hot water hose have separately a connector at an end of said cool water hose and an end of said hot water hose.
